(19) United States
(12) Patent Application Publication
(10) Pub. No.: US 2019/0363363 A1
(43) Pub. Date: Nov. 28, 2019

(54) ELECTRODE MATERIAL, ELECTRODE AND SOLID-STATE BATTERY COMPRISING A COMPLEX OXIDE WITH AN OLIVINE STRUCTURE

(71) Applicant: HYDRO-QUÉBEC, Montréal, Québec (CA)

(72) Inventors: Karim ZAGHIB, Longueuil, Québec (CA); Michel ARMAND, Paris (FR); Abdelbast GUERFI, Brossard, Québec (CA); Patrick BOUCHARD, Shawinigan, Québec (CA); Martin DONTIGNY, Varennes, Québec (CA); Julie HAMEL-PÂQUET, Montréal, Québec (CA); Pierre HOVINGTON, Boucherville, Québec (US)

(73) Assignee: HYDRO-QUÉBEC, Montréal, Québec (CA)

(21) Appl. No.: 16/482,924

(22) PCT Filed: Feb. 2, 2018
(86) PCT No.: PCT/CA2018/050117

§ 371 Date: Aug. 1, 2019

(30) Foreign Application Priority Data
Feb. 2, 2017 (CA) 2.956.857

(51) Int. Cl. H01M 4/58; H01M 4/62; H01M 10/0565; H01M 10/0525

(52) U.S. Cl. CPC H01M 4/5825; H01M 4/625; H01M 2004/028; H01M 10/0565; H01M 10/0525; H01M 4/622

(57) ABSTRACT

Described are positive electrode materials comprising at least one complex oxide of olivine structure, the complex oxide comprising a transition metal in oxidation state III, the positive electrodes comprising them and their manufacturing processes. Electrochemical cells comprising these electrodes, a polymer electrolyte and a negative electrode are also contemplated.

### RELATED APPLICATION

The present application claims priority, under applicable law, to Canadian patent application No. 2,956,857 filed on Feb. 2, 2017, the content of which is incorporated herein by reference in its entirety and for all purposes.

### TECHNICAL FIELD

This application relates to the field of electrochemical cells, especially to all-solid type batteries and to the use of charged olivine cathode.

### BACKGROUND

A battery operates by reversibly circulating ions between a negative electrode and a positive electrode, through an electrolyte comprising a salt, for example a lithium, sodium, or potassium salt, dissolved in a liquid, solid or gel polymer and/or solid ceramic-type solvent.

In the case of a lithium or lithium-ion battery, the negative electrode generally consists in a sheet of lithium, of lithium alloy or of a lithium-containing intermetallic compound. The negative electrode may also consist of a material capable of reversibly inserting lithium ions such as, for example, graphite or a metal oxide, the insertion material being used alone or in the form of a composite material containing, for example, at least one binder and an agent conferring electronic conduction, such as a carbon source.

Various complex oxides have been studied as positive electrode active material, acting as a lithium ions reversible insertion material. Mention may in particular be made of compounds having an olivine structure and responding to the formula LiMXO₄, where M represents a transition metal, or a mixture of transition metals and X is an element selected from S, P, Si, B and Ge. These complex oxides are generally used in the form of particles coated with carbon and/or bound to each other via carbon-carbon bonds.

Among the above-mentioned oxides, those in which M represents Fe, Mn or Co are of interest given their relatively low cost due to these metals high availability. For example, carbon-coated lithium iron phosphate (LiFePO₄) particles can generally be obtained in a relatively easy way, but the energy density of this type of material is rather low because of its relatively low voltage (in the order of 3.5 V v. Li/Li⁺). The iron atom in this type of compound is in oxidation state 2 (II).

Given the presence of the lithium ion in the starting oxide, the use of a cathode comprising LiFePO₄ results in the assembled battery being in a discharged state, making these batteries less safe after assembly. In addition, the safety of a battery using this cathode in a cell configuration with lithium metal being of concern, regulations for its transportation then become more stringent. Moreover, in such a configuration, the first charge induces lithium plating on the metallic anode, which involves the deposition of a thin Li layer on an already passivated surface. This plating will affect the stability of the lithium layer as a function of the battery cycling, resulting in a relatively limited reversibility. Despite the relatively low cost of iron-based materials, the cost of this material could be further reduced.

There is therefore a need for the development of a material excluding or reducing at least one disadvantage(s) of other known materials or having improved properties in comparison therewith.

### SUMMARY

The present application relates to a positive electrode material comprising at least one complex oxide of olivine structure, the complex oxide comprising a transition metal in oxidation state III, for example, a complex oxide of the formula MXO₄, where M is at least one transition metal of oxidation III (such as Fe, Ni, Mn or Co or a combination of at least two thereof), and X is selected from the elements S, P, Si, B and Ge, for example P or Si. According to one embodiment, the complex oxide is iron(III) phosphate of olivine structure, where the iron(III) may be, in part, replaced with an element selected from Ni, Mn, and Co, or a combination thereof, for instance, the complex oxide is FePO₄.

According to one embodiment, the complex oxide present in the electrode material is in the form of particles, for example, of microparticles and/or nanoparticles. According to one embodiment, the particles comprise microparticles. According to another embodiment, the particles comprise nanoparticles.

The electrode material as defined herein may further comprise an electronically conductive material (such as a carbon source). Examples of electronically conductive material include carbon black, Ketjen® carbon, Shawinigan carbon, graphite, graphene, carbon nanotubes, carbon fibers (such as vapor grown carbon fibers (VGCF)), non-powdery carbon obtained by carbonization of an organic precursor, or a combination of two or more thereof. According to one embodiment, the electronically conductive material comprises carbon black. In another embodiment, the electronically conductive material comprises carbon fibers. Alternatively, the electronically conductive material comprises carbon black and carbon fibers.

The electrode material as defined herein optionally comprises a binder, this binder comprising, for example, a linear, branched and/or crosslinked polyether polymer binder, a water-soluble binder, a fluorinated polymer binder, or one of their combinations. For example, the linear, branched and/or crosslinked polyether polymer binder may be selected from polymers based on poly(ethylene oxide) (PEO), on poly(propylene oxide) (PPO) or a mixture of the two, optionally comprising crosslinkable units. The water-soluble binder may be selected from SBR (styrene-butadiene rubber), NBR (acrylonitrile-butadiene rubber), HNBR (hydrogenated NBR), CHR (epichlorohydrin rubber), ACM (acrylate rubber), and mixtures thereof, optionally comprising CMC (carboxymethylcellulose). The fluorinated polymer binder may be selected from PVDF (polyvinylidene fluoride) and PTFE (polytetrafluoroethylene).

According to one example, the positive electrode material comprises a crosslinked binder, the FePO₄ complex oxide, a salt and an electronically conductive material as defined herein. For example, the salt is a lithium salt.

The present application also relates to a process for the preparation of an electrode comprising an electrode material as described herein, and comprising the steps of:
a) mixing the complex oxide and an electronically conductive material in the presence of a solvent;
b) applying the mixture obtained in (a) on a support (such as a current collector); and
c) drying of the applied mixture.

According to one embodiment, step (a) of the process further comprises the addition of a binder or a polymer binder precursor (e.g. monomer or oligomer).

For example, step (a) may comprise the addition of a polymer binder precursor based on a polyether polymer and a crosslinking agent, the process comprising a crosslinking step before, during or after step (c).

Positive electrodes comprising an electrode material as defined herein or obtained by a process of the present application are also contemplated, as well as electrochemical cells comprising such a positive electrode, an electrolyte film, and a negative electrode compatible with the positive electrode active material, i.e. with the complex oxide.

According to one embodiment, the negative electrode of the electrochemical cell comprises a film of an alkali metal such as sodium or lithium or one of their alloys, for example a film of metallic lithium or an alloy comprising at least 90% by weight of lithium. In another embodiment, the negative electrode comprises an anode complex oxide compatible with the complex oxide such as a lithium titanate.

According to another embodiment, the electrolyte film of the electrochemical cell comprises a salt in solution in a polar and solvating solid polymer. For example, the salt may be selected from LiTFSI, LiPF₆, LiDCTA, LiBETI, LiFSI, LiBF₄, LiBOB, and their combinations. Examples of polar and solvating solid polymers include linear, branched and/or crosslinked polyether polymers, such as those based on poly(ethylene oxide) (PEO), poly(propylene oxide) (PPO), or on a mixture or copolymer of both, optionally including crosslinkable units. Other additives may be present in the electrolyte such as glass particles, ceramics, for example nano-ceramics (such as Al₂O₃, TiO₂, SiO₂, and other similar compounds) may be added to the polymer electrolyte matrix, for example, to strengthen its mechanical properties and thus limit dendritic growth of the salt (Li, Na, etc.) plated upon charging.

According to one embodiment, the binder of the positive electrode is composed of a polymer identical to that used in the electrolyte film composition.

Other features of the present technology will be better understood upon reading the description below with reference to the figures.

### BRIEF DESCRIPTION OF THE FIGURES

FIG. 1 shows the potential (V) variation as a function of time for a battery comprising LiFePO₄ (LH6243C PT-945), compared to a battery comprising FePO₄ (LH6243D PT-2276, LH6243E PT-2276, and LH6243F PT-2276) according to some embodiments of the present technology (see Example 2).

FIG. 2 shows the potential variation as a function of time in a first charge for a battery comprising LiFePO₄ (LH6243C PT-945), compared to a battery comprising FePO₄ (LH6243E PT-2276) according to an embodiment of the present technology as described in Example 2.

FIG. 3 illustrates the Ragone diagram, namely the variation in capacity (mAh/g) as a function of the discharge rate for a battery comprising LiFePO₄ (LH6243C PT-945), compared to a battery comprising FePO₄ (LH6243D PT-2276) according to an embodiment of the present technology as described in Example 2.

FIG. 4 shows the capacity (solid symbols) and efficiency percentage (empty symbols) as a function of the number of cycles for FePO₄ (LH6243D PT-2276) according to an embodiment of the present technology as described in Example 2 compared to LiFePO₄ (Reference).

### DETAILED DESCRIPTION

The present application relates to the use of a complex oxide (for example of olivine structure), the complex oxide comprising a transition metal in oxidation state III, as electrochemically active material in the preparation of battery positive electrodes.

More particularly, the present application relates to a positive electrode material comprising at least one complex oxide of formula MXO₄, where M is at least one transition metal of oxidation III, for example Fe, Ni, Mn or Co or combinations thereof, and X is selected from S, P, Si, B and Ge, for example X is P or Si, preferably X is P. According to one example, the complex oxide is iron(III) phosphate of olivine structure.

The use of a complex oxide as defined in the present application makes it possible, inter alia, to obtain a safer battery assembled in the discharged state (for example Li/SPE/FePO₄), the use of less expensive materials, the use of a non-lithiated cathode, and/or the elimination of lithium plating on the pre-passivated metallic lithium anode during the first charge. In a battery configuration as described herein, the first electrochemical activity is a discharge, i.e. a lithiation of the olivine comprising a metal of oxidation III (such as FePO₄).

This step allows the deposition of a layer of lithium freshly dissolved from the metallic lithium during the battery's first charge.

Cost of the material can also be reduced by eliminating an atom (for instance, Li) from the olivine structure normally used in manufacturing. The present application demonstrates that this atom is not necessary for the manufacture of a positive electrode material of a battery comprising a metallic anode such as lithium.

The positive electrode material as described herein may comprise, in addition to the above-defined complex oxide particles (e.g., microparticles and/or nanoparticles), an electronically conductive material such as a carbon source, including, for example, carbon black, Ketjen® carbon, Shawinigan carbon, graphite, graphene, carbon nanotubes, carbon fibers (such as vapor grown carbon fibers (VGCF)), non-powdery adherent carbon obtained by carbonization of an organic precursor, or a combination of two or more thereof. A carbon source may also be present as a carbon coating on the complex oxide particles.

The positive electrode material may also include a binder. Non-limiting examples of binders include linear, branched and/or crosslinked polyether polymer binders (e.g., polymers based on poly(ethylene oxide) (PEO), or poly(propylene oxide) (PPO) or a mixture of both (including an EO/PO copolymer), and optionally comprising crosslinkable units), water-soluble binders (such as SBR (styrene-butadiene rubber), NBR (acrylonitrile-butadiene rubber), HNBR (hydrogenated NBR), CHR (epichlorohydrin rubber), ACM (acrylate rubber)), or fluorinated polymer-type binders (such as PVDF (polyvinylidene fluoride), PTFE (polytetrafluoroethylene)), and their combinations). Some binders, like those soluble in water, may also include an additive such as CMC (carboxymethylcellulose).

Additives may also be present in the positive electrode material, such as salts, for example lithium salts in the case of lithium or lithium-ion batteries (such as LiTFSI, LiPF₆, LiDCTA, LiBETI, LiFSI, LiBF₄, LiBOB, etc.), or inorganic particles of ceramic or glass type, or other compatible active materials (for example, sulfur).

In one example, the electrode material comprises between 50% and 95% by weight of the complex oxide, or between 60% and 80% by weight of the complex oxide. The material may also comprise between 5% and 40% by weight of binder, or between 15% and 35% by weight of binder. The electrode material may also comprise 10% by weight or less of a salt, for example, between 3% and 7% by weight of salt. Finally, the material may comprise 10% by weight or less of an electronically conductive material or a mixture of electronically conductive materials, for example, between 3% and 7% of an electronically conductive material or of a mixture of electronic conductive materials. For example, the electronically conductive material mixture comprises carbon black and carbon fibers (such as VGCF), which mixture may comprise both conductive materials in any proportion, for example in a weight ratio of about 1:1.

The process used for the electrode material preparation depends on the elements being combined. For example, a complex oxide as defined herein may be mixed with an electronically conductive material in the presence of a solvent, be applied on a support, for example a current collector, and then dried. This mixture may also include one of the binders described herein or a polymer binder precursor (e.g., monomer or prepolymer before crosslinking).

The mixture for application may also optionally include additional components such as inorganic particles, ceramics, salts, and the like.

The positive electrode may be used in a battery with any type of negative electrode electrochemically compatible with the positive electrode active material. For example, the negative electrode may comprise an alkali metal film (such as sodium or lithium), for example, a film of metallic lithium or of an alloy comprising at least 90% by weight of lithium, or at least 95% lithium. An example of a negative electrode comprises an active lithium film prepared by the rolling, between rolls, of a lithium sheet. The produced film is then quickly combined with the other battery elements. According to a process, the lithium film comprises a thin (e.g. 50 Å or less) and constant passivation layer. For example, the lithium film is prepared according to the method used in PCT Application No. WO2008/009107 and may also include the use of a lubricating agent, as described in PCT Application No. WO 2015/149173, during its formation. Other negative electrode materials include anode complex oxides such as lithium titanates, or lithium vanadium oxides.

The electrolyte is preferably a solid polymer electrolyte (SPE) formed of a thin ion conductive polymer layer. Examples of solid polymer electrolytes may generally comprise one or more solid polar polymers, crosslinked or not, and alkali metal salts, for example, lithium salts such as LiTFSI, LiPF₆, LiDCTA, LiBETI, LiFSI, LiBF₄, LiBOB, etc. Polyether-type polymers, such as linear, branched and/or crosslinked polymers based on poly(ethylene oxide) (PEO), poly(propylene oxide) (PPO), or a mixture of both (polymer mixture or EO/PO copolymer) can be used, but several other lithium compatible polymers are also known for the production of SPE. Examples of such polymers include star-shaped or comb-shaped multi-branched polymers such as those described in PCT application published as WO2003/063287 (Zaghib et al.). Other additives may be present in the electrolyte such as glass particles, ceramics, for example nano-ceramics (such as Al₂O₃, TiO₂, SiO₂, and other similar compounds) may be added to a polymer electrolyte matrix. For example, such additives may make it possible to strengthen mechanical properties, increase ionic conductivity, and/or limit dendritic growth of the salt (Li, Na, etc.) plated during charging.

In one example, the binder used in the cathode material comprises the same polymer as that used in the solid polymer electrolyte and is of the polyether polymer type.

Electrochemical cells described herein and batteries comprising them can be used, for example, in electric or hybrid vehicles, or in information technology devices. For example, the intended use includes nomadic devices, such as mobile phones, cameras, tablets or laptops, electric or hybrid vehicles, or in renewable energy storage.

The following examples illustrate the invention and should not be construed as limiting the scope of the invention as described.

### EXAMPLES

### Example 1—Preparation of Cathodes

a. FePO₄ Cathode

A mixture is prepared with the following elements: FePO₄ (15 g), PEO-based polymer including crosslinkable units (5.7 g) as described in Canadian patent No. 2,111,047, a mixture of acetonitrile/toluene solvents in a ratio of 80:20 (14.1 g), a lithium salt (LiTFSI, 1.23 g), carbon black (0.56 g), carbon fibers (VGCF, 0.57 g) and a crosslinking agent (Irgacure™ 651, 0.079 g). The mixture is applied as a film by the Doctor blade method on an aluminum current collector, dried first at 75° C. for 15 minutes, then crosslinked for 2 minutes under UV, and finally dried at 75° C. for 18 hours.

b. LiFePO₄ Cathode (Comparative)

A mixture is prepared with the following elements: LiFePO₄ (21.7 g), PEO-based polymer comprising crosslinkable units (8.17 g) as described in Canadian patent No. 2,111,047, a mixture of acetonitrile/toluene solvents in an 80:20 ratio (20.26 g), a lithium salt (LiTFSI, 1.87 g), carbon black (0.78 g), carbon fibers (VGCF, 0.78 g) and a crosslinking agent (Irgacure™ 651, 0.069 g). The mixture is applied as a film by the Doctor blade method on an aluminum current collector, first dried at 75° C. for 15 minutes, then crosslinked for 2 minutes under UV, and finally dried at 75° C. for 18 hours.

### Example 2—Preparation of Cells

A polymer electrolyte is prepared by mixing a PEO-based polymer comprising crosslinkable units (20 g) as described in Canadian patent No. 2,111,047, a lithium salt (LiTFSI, 6.5 g) and a crosslinking agent (Irgacure™ 651, 0.29 g) in an acetonitrile/toluene 80:20 mixture (49.6 g). The polymer film is applied by the Doctor blade method on a polypropylene (PP) film, first dried at 75° C. for 15 minutes and crosslinked for 2 minutes under UV, and then dried again at a temperature of 85° C. for 18 h. The PP film is removed before battery assembly.

The cells are manufactured by stacking the films following the sequence: polymer electrolyte film on the cathode (FePO₄ or LiFePO₄ cathode) followed by a lithium film on the electrolyte film, and by pressing the whole stack at 80° C. for 30 minutes.

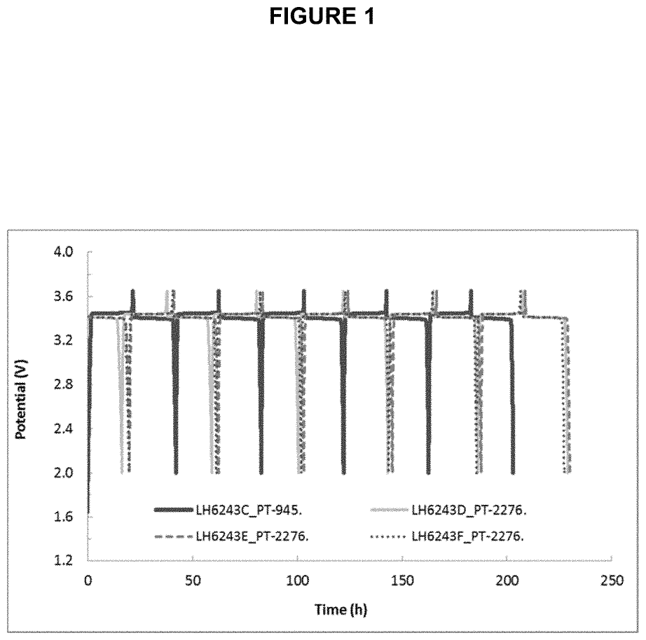

The cells were tested, and the comparative results are shown in FIGS. 1 to 4. PT-2276 cells represent cells with a FePO₄ cathode prepared according to the method of Example 1(a). The PT-945 cell represents a cell with a LiFePO₄ cathode prepared according to the method of Example 1(b).

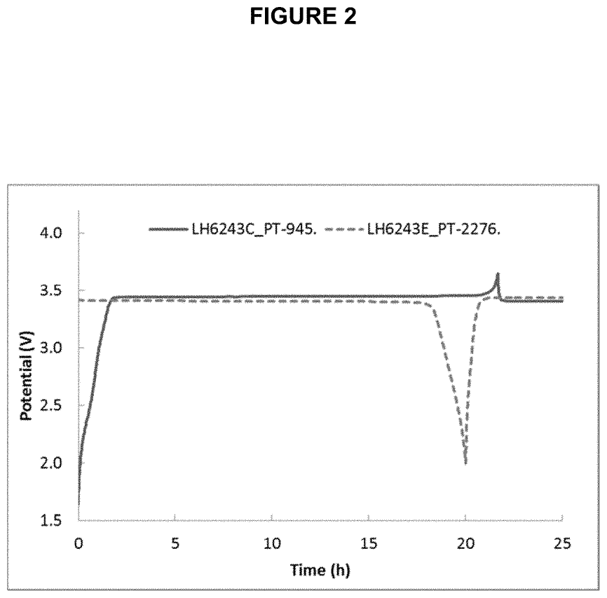

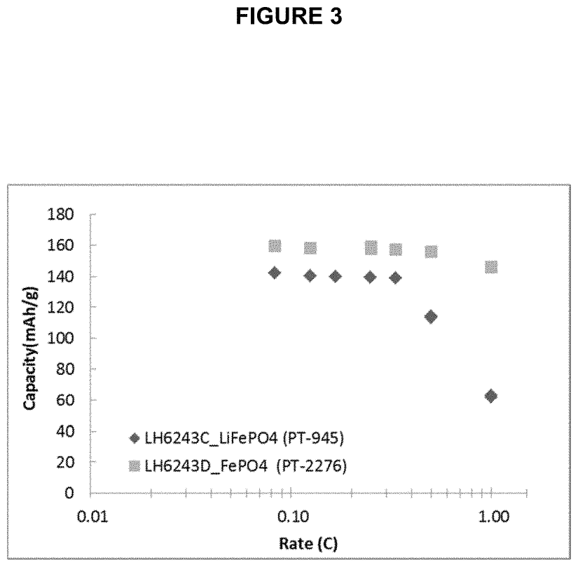

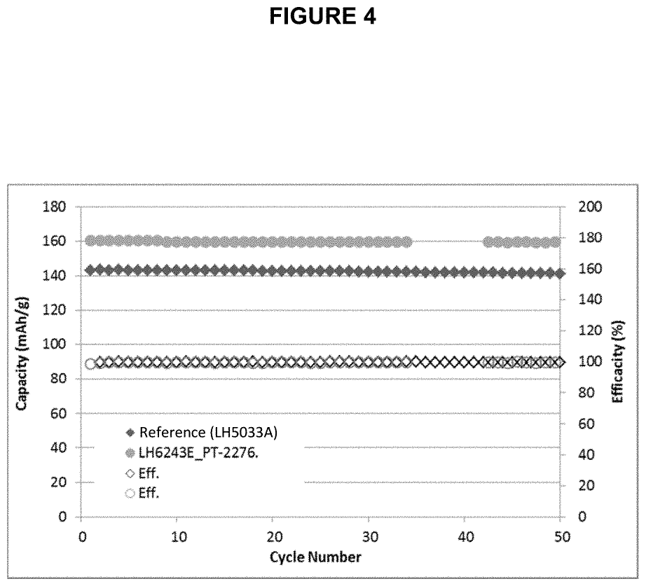

FIG. 2 illustrates the first lithium dissolution for the FePO₄ cell and the first plating for the cell comprising LiFePO₄. FIG. 3 demonstrates a better power performance when using a FePO₄ cathode compared to a LiFePO₄ cathode. FIG. 4 demonstrates a higher reversible capacity for a cell comprising the FePO₄ cathode.

Several modifications could be made to either of the above-described embodiments without departing from the scope of the invention as contemplated. References, patents or scientific literature documents referred to herein are hereby incorporated by reference in their entirety and for all purposes.

1. A positive electrode material comprising at least one complex oxide of olivine structure, the complex oxide comprising a transition metal in oxidation state III.

2. The positive electrode material according to claim 1, wherein the complex oxide is of formula MXO₄, wherein M is at least one transition metal of oxidation III, and X is selected from the elements S, P, Si, B and Ge.

3. The positive electrode material according to claim 2, wherein M is Fe, Ni, Mn or Co or a combination of at least two thereof.

4. The positive electrode material according to claim 2 or 3, wherein X is P or Si, preferably X is P.

5. The positive electrode material according to claim 4, wherein X is P.

6. The positive electrode material according to any one of claims 1 to 5, wherein the complex oxide is iron(III) phosphate of olivine structure, wherein the iron(III) is optionally partly replaced with an element selected from Ni, Mn, and Co, or a combination thereof.

7. The positive electrode material according to claim 6, wherein the complex oxide is FePO₄.

8. The positive electrode material according to any one of claims 1 to 7, wherein the complex oxide is in the form of particles.

9. The positive electrode material according to claim 8, wherein the particles comprise microparticles.

10. The positive electrode material according to claim 8, wherein the particles comprise nanoparticles.

11. The positive electrode material according to any one of claims 1 to 10, further comprising an electronically conductive material.

12. The positive electrode material according to claim 11, wherein the electronically conductive material comprises carbon black, Ketjen® carbon, Shawinigan carbon, graphite, graphene, carbon nanotubes, carbon fibers (such as vapor grown carbon fibers (VGCF)), non-powdery carbon obtained by carbonization of an organic precursor, or a combination of at least two thereof.

13. The positive electrode material according to claim 12, wherein the electronically conductive material comprises carbon black.

14. The positive electrode material according to claim 12 or 13, wherein the electronically conductive material comprises carbon fibers.

15. The positive electrode material according to any one of claims 1 to 14, further comprising a binder.

16. The positive electrode material according to claim 15, wherein the binder comprises a linear, branched and/or crosslinked polyether polymer binder, a water-soluble binder, a fluorinated polymer binder, or one of their combinations.

17. The positive electrode material according to claim 16, wherein the linear, branched and/or crosslinked polyether polymer binder is selected from polymers based on poly(ethylene oxide) (PEO), on poly(propylene oxide) (PPO) or a mixture thereof, optionally comprising crosslinkable units.

18. The positive electrode material according to claim 16, wherein the water-soluble binder is selected from SBR (styrene-butadiene rubber), NBR (acrylonitrile-butadiene rubber), HNBR (hydrogenated NBR), CHR (epichlorohydrin rubber), ACM (acrylate rubber), and their mixtures, and optionally comprising CMC (carboxymethylcellulose).

19. The positive electrode material according to claim 16, wherein the fluorinated polymer binder is selected from PVDF (polyvinylidene fluoride) and PTFE (polytetrafluoroethylene).

20. The positive electrode material according to claim 17, wherein the binder is crosslinked, the complex oxide is FePO₄, said material further comprising a salt and an electronically conductive material.

21. A process for the preparation of a positive electrode comprising a positive electrode material as defined in any one of claims 1 to 20, the process comprising the steps of:
a) mixing the complex oxide and an electronically conductive material in the presence of a solvent;
b) applying the mixture obtained in (a) on a support; and
c) drying of the mixture applied in (b).

22. The process according to claim 21, wherein the support is a current collector.

23. The process according to claim 21 or 22, wherein step (a) further comprises adding a binder or a polymer binder precursor (e.g. monomer or oligomer).

24. The process according to claim 23, wherein step (a) comprises adding a polymer binder precursor based on a polyether polymer and a crosslinking agent, the process comprising a crosslinking step before, during and/or after step (c).

25. A positive electrode comprising a positive electrode material as defined in any one of claims 1 to 20 or obtained by a process as defined in any one of claims 21 to 24.

26. An electrochemical cell comprising a positive electrode as defined in claim 25, an electrolyte, and a negative electrode.

27. The electrochemical cell according to claim 26, wherein the negative electrode comprises a film of metallic lithium or of an alloy comprising at least 90% by weight of lithium.

28. The electrochemical cell according to claim 26, wherein the negative electrode comprises a complex oxide electrochemically compatible with the complex oxide of the positive electrode (for example, a lithium titanate).

29. The electrochemical cell according to any one of claims 26 to 28, wherein the electrolyte is a film comprising a salt dissolved in a polar and solvating solid polymer.

30. The electrochemical cell according to claim 29, wherein the salt is selected from LiTFSI, LiPF₆, LiDCTA, LiBETI, LiFSI, LiBF₄, LiBOB, and their combinations.

31. The electrochemical cell according to claim 29 or 30, wherein the polar and solvating solid polymer is a linear, branched and/or crosslinked polyether polymer.

32. The electrochemical cell according to claim 31, wherein the linear, branched and/or crosslinked polyether polymer is based on poly(ethylene oxide) (PEO), poly(propylene oxide) (PPO), or a mixture of both, and optionally crosslinkable units.

33. The electrochemical cell according to any one of claims 26 to 32, wherein the positive electrode comprises a binder, said binder being composed of a polymer identical to a polymer used in the composition of the electrolyte film.
